(19) United States
(12) Patent Application Publication
(10) Pub. No.: US 2024/0297399 A1
(43) Pub. Date: Sep. 5, 2024

(54) BATTERY PACK ENCLOSURE WITH INTEGRATED THERMAL RUNAWAY CELL VENTING FOR ISOLATION OF SENSITIVE COMPONENTS

(71) Applicant: GM GLOBAL TECHNOLOGY OPERATIONS LLC, Detroit, MI (US)

(72) Inventors: Ryan P. Hickey, Austin, TX (US); Alexander M. Bilinski, Avoca, MI (US); Phillip D. Hamelin, Clarkston, MI (US)

(73) Assignee: GM GLOBAL TECHNOLOGY OPERATIONS LLC, Detroit, MI (US)

(21) Appl. No.: 18/177,856

(22) Filed: Mar. 3, 2023

(51) Int. Cl. H01M 50/367; H01M 50/209; H01M 50/271

(52) U.S. Cl. CPC H01M 50/367; H01M 50/209; H01M 50/271; H01M 2220/20

(57) ABSTRACT

A battery pack includes a battery pack enclosure surrounded by an external environment and housing battery cells. The battery pack enclosure includes a tray having a first compartment housing the battery cells and a second compartment configured to collect high-temperature gas emitted by the battery cell(s) during a thermal runaway and expel the gas to the external environment. The battery pack enclosure also includes a cover configured to engage the tray and seal the enclosure. The first compartment is arranged between the second compartment and the cover. The battery pack also includes a temperature-sensitive component arranged inside the enclosure between the second compartment and the cover. The battery pack additionally includes a vent channel fluidly connecting the first and second compartments and configured to direct the high-temperature gas from the first compartment to the second compartment, thereby diverting the gas away from the temperature-sensitive component.

### INTRODUCTION

The present disclosure relates to a battery pack enclosure with integrated battery cell venting providing isolation and protection from exposure of sensitive components to battery cell thermal runaway.

A battery array, such as a battery module, pack, etc., typically includes a plurality of battery cells in relatively close proximity to one another. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental, and ease-of-use benefits compared to disposable batteries.

Rechargeable batteries may be used to power such diverse items as toys, consumer electronics, and motor vehicles. Particular chemistries of rechargeable batteries, such as lithium-ion cells, as well as external factors, may cause internal reaction rates generating significant amounts of thermal energy. Such chemical reactions may cause more heat to be generated by the batteries than is effectively withdrawn. Exposure of a battery cell to elevated temperatures over prolonged periods may cause the cell to experience a thermal runaway event. Accordingly, a thermal runaway event starting within an individual cell may lead to the heat spreading to adjacent cells in the battery array and cause the thermal runaway event to affect the entire array and affect nearby temperature-sensitive components, such as controllers, sensors, battery terminals and connectors, etc.

### SUMMARY

A battery pack includes a battery pack enclosure surrounded by an external environment and housing a plurality of battery cells. The battery pack enclosure includes an enclosure tray having a first compartment configured to house the plurality of battery cells and a second compartment configured to collect high-temperature gas emitted by at least one of the plurality of battery cells during a thermal runaway and expel the high-temperature gas to the external environment. The battery pack enclosure also includes an enclosure cover configured to engage the enclosure tray and seal the battery pack enclosure. The first compartment is arranged between the second compartment and the enclosure cover. The battery pack also includes a temperature-sensitive component arranged inside the battery pack enclosure between the second compartment and the enclosure cover. The battery pack additionally includes a vent channel fluidly connecting the first compartment to the second compartment and configured to direct the high-temperature gas from the first compartment to the second compartment, thereby diverting the high-temperature gas away from the temperature-sensitive component.

The battery pack enclosure may additionally include a baffle arranged in a flow of the high-temperature gas directed by the vent channel and configured to slow and cool the high-temperature gas prior to the high-temperature gas entering the second compartment.

The enclosure tray may include an endcap in fluid communication with the second compartment.

The baffle may be located in the endcap.

The endcap may be constructed as a separate component from the first and second compartments and joined to the second compartment to thereby form the enclosure tray.

The battery pack may include a ventilation plug arranged in the battery pack enclosure and configured to interface with the endcap. The ventilation plug is also configured to open fluid communication between the endcap and the external environment when the ventilation plug is impinged on by the high-temperature gas.

The battery pack enclosure may additionally include a particle screen arranged in the endcap upstream of the ventilation plug and configured to filter debris out of the high-temperature gas.

The ventilation plug may be constructed from one of metal and plastic and is configured to be breached by at least one of increased pressure and temperature when impinged on by the high-temperature gas.

The enclosure tray may include a false floor and the second compartment may be incorporated into the false floor.

The vent channel may be incorporated into the false floor.

A motor vehicle having a power-source and the above-disclosed battery pack configured to supply electric energy to the power-source is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing multiple power-sources and a battery system including a battery pack having battery cells organized in module(s) configured to generate and store electrical energy.

FIG. 2 is a schematic perspective view of the battery pack shown in FIG. 1, having a battery pack enclosure including a battery pack cover and a battery pack tray, according to the disclosure.

FIG. 3 is a schematic perspective view of the battery pack shown in FIG. 1, illustrated with the battery pack cover removed.

FIG. 4 is a schematic perspective partial view of the battery pack shown in FIG. 3, illustrating first and second compartments of the battery pack tray and having an endcap arranged in the second compartment, according to the disclosure.

FIG. 5 is a schematic perspective partial view of the battery pack shown in FIG. 4, illustrating first and second compartments of the battery pack tray but with the endcap removed to show vent channels under battery cells, according to the disclosure.

FIG. 6 is a schematic side partial view of the battery pack shown in FIG. 3, illustrating a false floor of the tray's second compartment and ventilation plugs and a particle screen arranged in the endcap, according to the disclosure.

FIG. 7 is a schematic top partial view of the battery pack shown in FIG. 3, illustrating baffles arranged in a flow of high-temperature gas directed by the vent channels, according to the disclosure.

### DETAILED DESCRIPTION

Those having ordinary skill in the art will recognize that terms such as “above”, “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

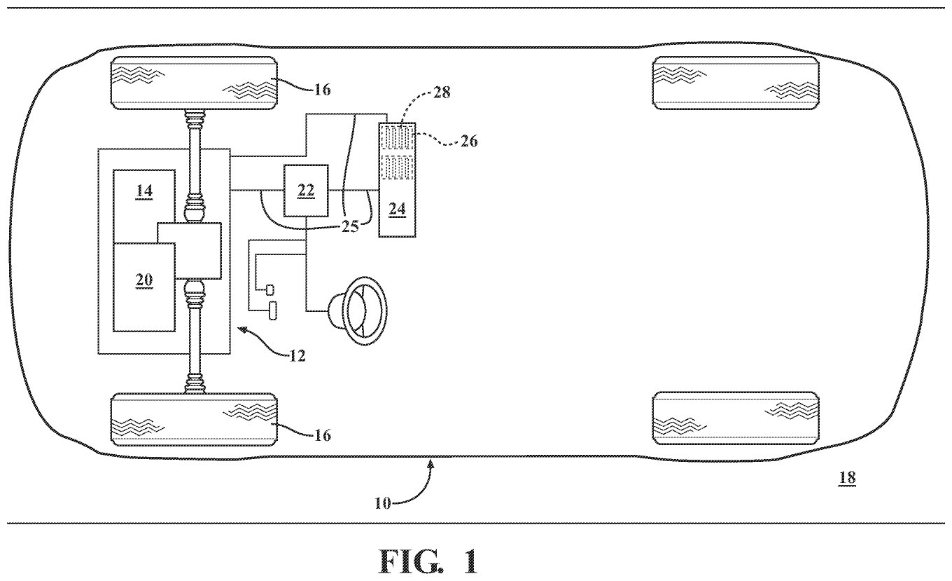

Referring to FIG. 1, a motor vehicle 10 having a powertrain 12 is depicted. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source 14 configured to generate a power-source torque T (shown in FIG. 1) for propulsion of the vehicle 10 via driven wheels 16 relative to a road surface 18. The power-source 14 is depicted as an electric motor-generator.

As shown in FIG. 1, the powertrain 12 may also include an additional power-source 20, such as an internal combustion engine. The power-sources 14 and 20 may act in concert to power the vehicle 10. The vehicle 10 additionally includes an electronic controller 22 and a battery pack 24 configured to generate and store electrical energy through heat-producing electro-chemical reactions for supplying the electrical energy to the power-sources 14 and 20. The electronic controller 22 may be a central processing unit (CPU) that regulates various functions of the vehicle 10, or a powertrain control module (PCM) configured to control the powertrain 12 to generate a predetermined amount of power-source torque T. The battery pack 24 may be connected to the power-sources 14 and 20, the electronic controller 22, as well as other vehicle systems via a high-voltage BUS 25. Although the battery pack 24 is described herein primarily with respect to a vehicle environment, nothing precludes the subject battery system from being employed to power other, non-automotive systems.

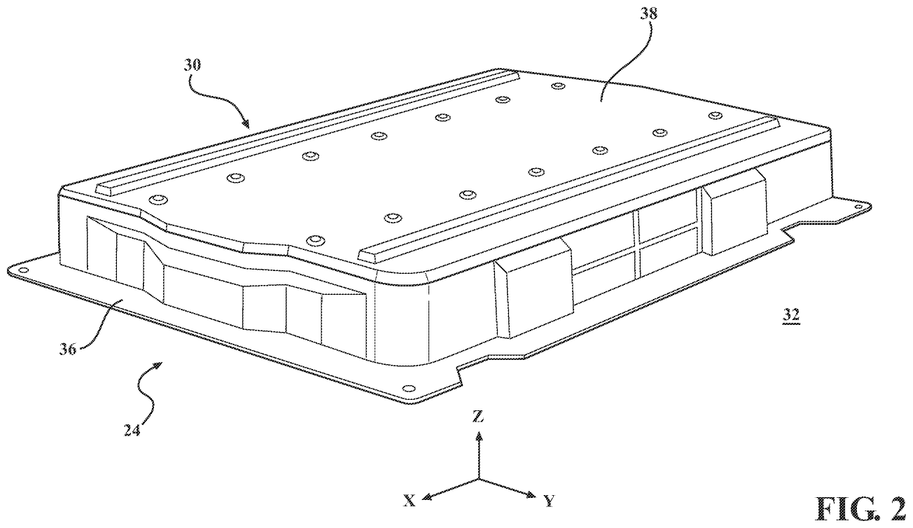

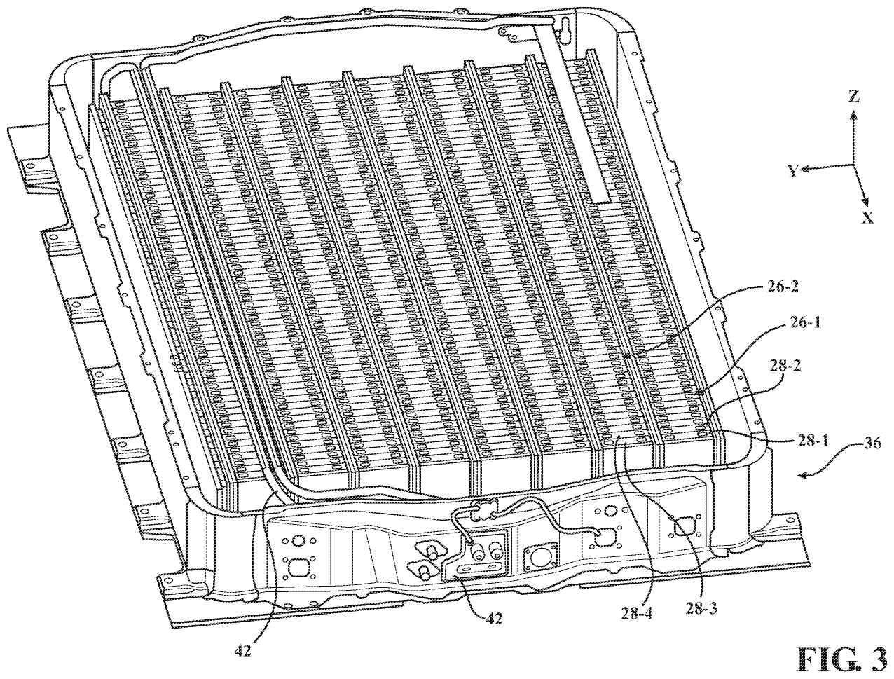

With continued reference to FIG. 1, the battery pack 24 includes multiple sections or modules 26, each having a plurality of individual battery cells 28. As shown in FIG. 2, the battery pack 24 also includes a battery pack enclosure 30 configured to house the first and second battery modules 26-1, 26-2. The battery pack enclosure 30 is surrounded by an ambient environment 32, i.e., environment external to the battery pack enclosure. The battery pack enclosure 30 is configured as a self-contained system designed to manage high-temperature gases emitted by individual battery cells 28, such as during a battery cell thermal runaway event, and expel the high-temperature gases to the external environment 32. The battery pack enclosure 30 includes an enclosure tray 36 (shown in FIGS. 2 and 3) and an enclosure cover 38 (shown in FIG. 2). The enclosure cover 38 is generally positioned above the battery cells 28 and configured to engage the enclosure tray 36 to substantially seal the battery pack enclosure 30 and its contents from the external environment 32. As shown, the battery pack enclosure 30 is arranged in a horizontal X-Y plane, such that the enclosure cover 38 is positioned above the enclosure tray 36 when viewed along a Z-axis.

As shown in FIG. 3, the battery pack 24 includes a first module 26-1 and a neighboring, directly adjacent, second module 26-2, with each constituent battery cell 28 extending generally upward, i.e., in the Z direction. Specifically, the first module 26-1 includes at least battery cells 28-1 and 28-2, while the second module 26-2 includes at least battery cells 28-3 and 28-4. Although two modules 26-1, 26-2 having battery cells 28-1, 28-2 and battery cells 28-3, 28-4, respectively, are shown, nothing precludes the battery pack 24 from having a greater number of such modules with a greater number of battery cells arranged therein. The battery cells in the battery pack 24, such as the cells 28-1, 28-2, 28-3, and 28-4 may have an encased prismatic (shown in FIGS. 3-5) or cylindrical (not shown) configuration with specific features and/or provisions for releasing of gas out of the respective cell.

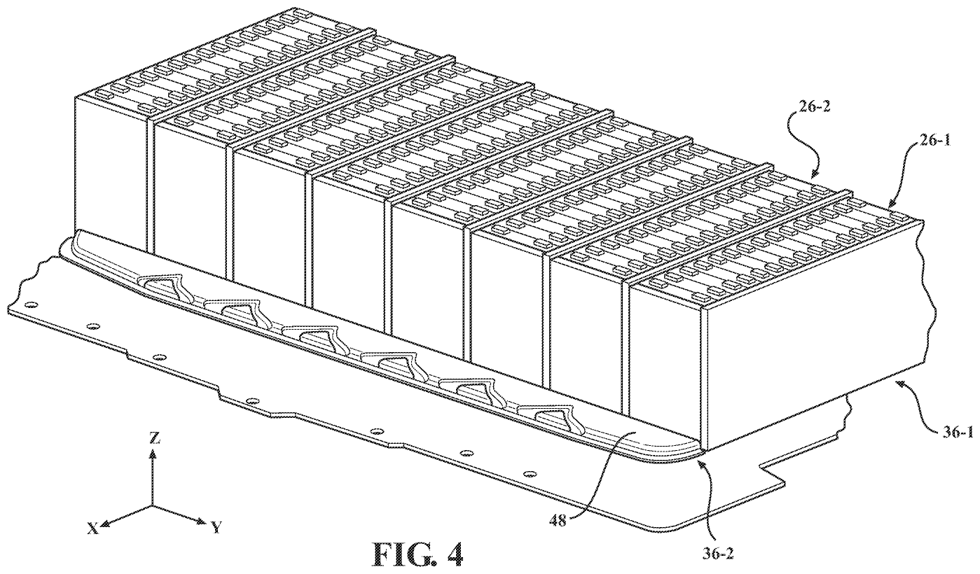

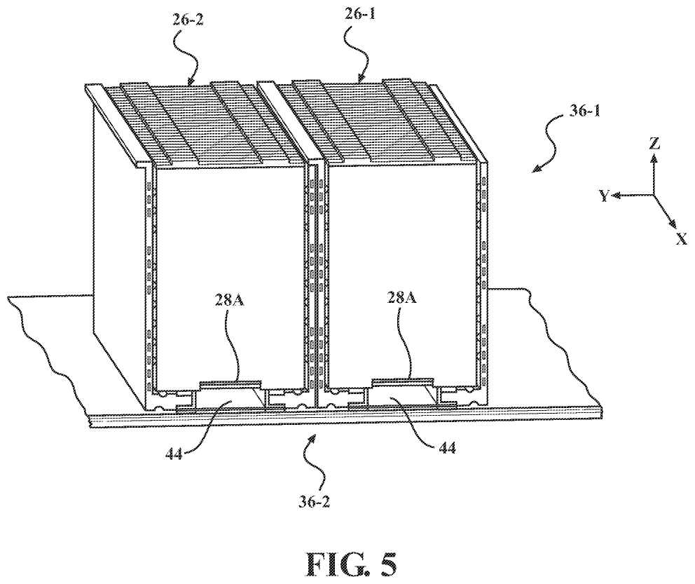

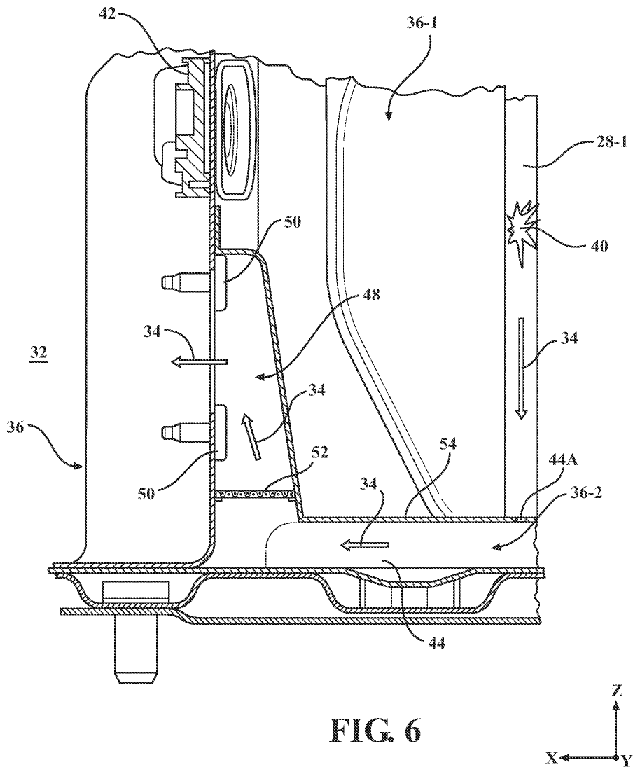

As shown in FIGS. 4 and 5, the enclosure tray 36 includes a first compartment 36-1 and a second compartment 36-2. The first compartment 36-1 of the enclosure tray 36 is configured to house each of the battery cells 28-1, 28-2, 28-3, 28-4 of the first and second modules 26-1, 26-2. The enclosure tray 36 also has a second compartment 36-2 configured to collect high-temperature gas 34 emitted by at least one of the battery cells 28-1, 28-2, 28-3, 28-4 during a thermal runaway event (identified via numeral 40 in FIG. 6). The second compartment 36-2 is additionally configured to expel the high-temperature gas 34 to the external environment 32. The first compartment 36-1 is arranged between the second compartment 36-2 and the enclosure cover 38. In other words, when the battery pack 24 is positioned substantially horizontally in the X-Y plane, the enclosure cover 38 defines a top portion of the battery pack enclosure 30, the first compartment 36-1 is arranged below the enclosure cover, and the second compartment 36-2 is arranged below the first compartment defining a bottom portion of the battery pack enclosure.

As shown in FIGS. 3 and 6, the battery pack 24 also includes temperature-sensitive components 42 arranged inside the battery pack enclosure 30. The temperature-sensitive components 42 may be spaced throughout the battery pack enclosure 30. The temperature-sensitive components 42 may be generally located between the second compartment 36-2 and the enclosure cover 38, for example in the first compartment 36-1 near the battery cells 28-1, 28-2, 28-3, 28-4 and proximate the enclosure cover. Examples of relevant temperature-sensitive components 42 may include battery diagnostic and cell monitoring electronics, controllers, coolant lines and connectors for a cold-plate, high-voltage BUS bars, battery terminals, as well as various plastic components.

Generally, during extreme conditions, such as during a thermal runaway event, casing of the battery cell undergoing the event may rupture and release gases and debris into the battery pack. As a result, excess thermal energy will typically be transferred between neighboring battery cells and neighboring battery modules, leading to propagation of the thermal runaway through a battery pack. The term “thermal runaway event” generally refers to an uncontrolled increase in temperature in a battery system. During a thermal runaway event, the generation of heat within a battery system or a battery cell exceeds the dissipation of heat, thus leading to a further increase in temperature. A thermal runaway event may be triggered by various conditions, including a short circuit within the cell, improper cell use, physical abuse, manufacturing defects, or exposure of the cell to extreme external temperatures.

For example, in the event one battery cell, such as the cell 28-1 in the battery module 26-1, experiences the thermal runaway event 40, the excess gases generated by such an event would give rise to highly elevated internal cell pressures having a tendency to rupture the casing of the subject cell. Prismatic and cylindrical cell casings typically include designed vents 28A (shown in FIG. 5) configured to open or rupture under thermal runaway to release excess gas (and pressure) from inside the cell. As employed herein, such vents are located on a bottom surface of the corresponding prismatic or cylindrical battery cell casing. In the event of the battery cell 28-1 casing rupture, emitted high-temperature gas 34 may send cell debris through the first module 26-1, triggering a thermal runaway of the battery cell 26-2. A temperature of the gas 34 may be up to 1,500 degrees Celsius. The elevated pressure high-temperature gas 34 may then distort the battery enclosure cover 38 and pass to battery cells 28-3, 28-4 in the neighboring second battery module 26-2. Accordingly, such transfer of high-temperature gases 34 typically increases the likelihood of a chain reaction affecting a significant part of the battery pack 24 and in the process damaging the enclosed temperature-sensitive components 42.

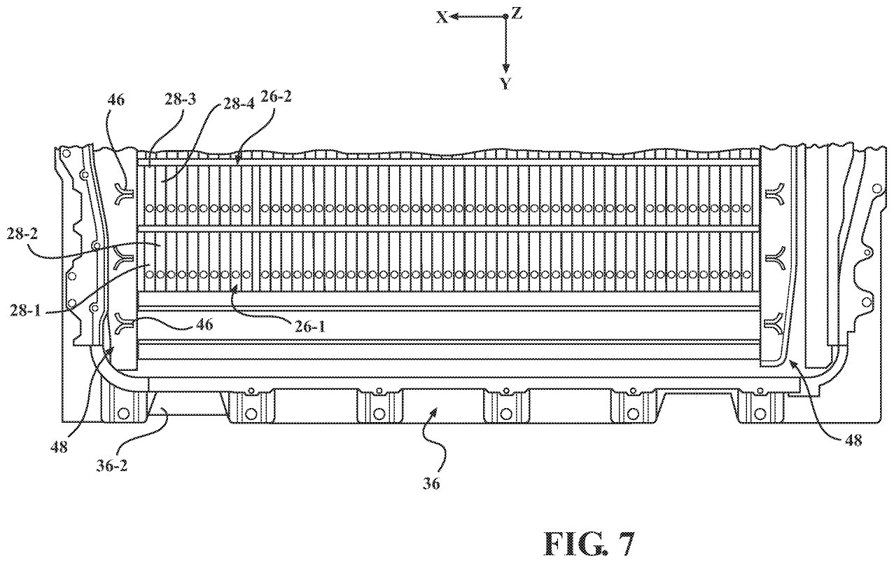

As shown in FIGS. 5 and 6, the battery pack 24 additionally includes one or more vent channels 44 configured to interface with bottom surfaces of battery cells, specifically under the corresponding casing thermal runaway vents 28A. Each vent channel 44 may be arranged under the first compartment 36-1, e.g., within the second compartment 36-2, and configured to fluidly connect the first compartment to the second compartment. The vent channel(s) 44 are configured to direct the high-temperature gas 34 from the first compartment 36-1 to the second compartment 36-2, such as via apertures 44A (shown in FIG. 6), and thereby divert, i.e., deflect or reroute, the high-temperature gas away from the temperature-sensitive component(s) 42. The battery pack enclosure 30 may additionally include baffles 46 arranged in a flow of the high-temperature gas 34 directed by the vent channel 44. As shown in FIG. 7, one baffle 46 may be arranged at each end of an individual channel 44. Each baffle 46 is configured to slow the flow of the high-temperature gas 34 to thereby cool the gas prior to its entry into the second compartment 36-2.

The enclosure tray 36 may also include at least one endcap 48, as shown in FIGS. 4, 6, and 7. In a particular embodiment, the enclosure may include two endcaps 48, such as one at each end of the vent channel 44. Each endcap 48 is in fluid communication with the second compartment 36-2 and specifically with the vent channel(s) 44. One or more baffles 46 may be located in each endcap 48. The endcaps 48 may be constructed as separate units or components from the first and second compartments 36-1, 36-2 and joined, e.g., mounted or welded, to the second compartment to thereby form the enclosure tray 36. As shown in FIG. 6, the battery pack enclosure 30 may additionally include one or more ventilation plugs 50 arranged in the battery pack enclosure 30. The ventilation plug(s) 50 may be configured to interface with the endcap(s) 48 and open fluid communication between the corresponding endcap and the external environment 32 when the subject ventilation plug is impinged on by the high-temperature gas 34. The ventilation plug 50 may be constructed from a material configured to be breached by at least one of increased pressure and temperature when impinged on by the high-temperature gas 34, such as metal or plastic.

The battery pack enclosure 30 may further include one or more particle screens 52 (shown in FIG. 6). Each particle screen 52 may be arranged in one of the endcaps 48 in a path of the high-temperature gas 34 upstream of an associated ventilation plug 50. The subject particle screen(s) 52 may be configured to filter battery cell debris out of the high-temperature gas 34 and block escape of the debris through the ventilation plug(s) 50. As also shown in FIG. 6, the enclosure tray 36 may include a false floor 54 subdividing the tray into the first and second compartments 36-1, 36-2. The second compartment 36-2 and the vent channels 44 may be incorporated into the false floor 54. Accordingly, the false floor 54 may provide structural support for the battery cells 28-1, 28-2, 28-3, 28-4 of modules 26-1, 26-2 along with a space under the battery cells for collection and channeling of the emitted high-temperature gas 34.

Overall, during operation of the battery pack 24, the two-compartment structure of the battery pack enclosure 30 is configured to redirect high-temperature gases emitted by battery cell(s) undergoing a thermal runaway from an area above the battery cells to an under-cell compartment and from there to the ambient environment. The structure of the pack enclosure 30 thereby diverts the high-temperature gases away from the battery pack's temperature-sensitive components permitting their prolonged functionality. Specifically, the battery pack enclosure 30 includes vent channel(s) 44 fluidly connecting the two compartments. The battery pack enclosure 30 may also include baffle(s) 46 arranged in the vent channel(s) 44 for cooling of the emitted high-temperature gas and particle screen(s) 52 configured to filter battery cell debris out of the gas. The battery pack enclosure 30 may incorporate the channel(s) 44 into a false (under battery cell) floor. Additionally, ventilation plug(s) 50 may be employed for controlling release of the high-temperature gases to the ambient environment, thereby mitigating propagation of a thermal runaway within the battery pack 24 and protecting the battery pack's temperature-sensitive components.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A battery pack comprising:
a plurality of battery cells;
a battery pack enclosure surrounded by an external environment, the battery pack enclosure including:
an enclosure tray having a first compartment configured to house the plurality of battery cells and a second compartment configured to collect high-temperature gas emitted by at least one of the plurality of battery cells during a thermal runaway and expel the high-temperature gas to the external environment; and
an enclosure cover configured to engage the enclosure tray and seal the battery pack enclosure, wherein the first compartment is arranged between the second compartment and the enclosure cover;
a temperature-sensitive component arranged inside the battery pack enclosure between the second compartment and the enclosure cover; and
a vent channel fluidly connecting the first compartment to the second compartment and configured to direct the high-temperature gas from the first compartment to the second compartment, thereby diverting the high-temperature gas away from the temperature-sensitive component.

2. The battery pack of claim 1, wherein the battery pack enclosure additionally includes a baffle arranged in a flow of the high-temperature gas directed by the vent channel and configured to slow and cool the high-temperature gas prior to the high-temperature gas entering the second compartment.

3. The battery pack of claim 2, wherein the enclosure tray includes an endcap in fluid communication with the second compartment.

4. The battery pack of claim 3, wherein the baffle is located in the endcap.

5. The battery pack of claim 3, wherein the endcap is constructed as a separate component from the first and second compartments and joined to the second compartment to thereby form the enclosure tray.

6. The battery pack of claim 3, further comprising a ventilation plug arranged in the battery pack enclosure and configured to interface with the endcap and open fluid communication between the endcap and the external environment when the ventilation plug is impinged on by the high-temperature gas.

7. The battery pack of claim 6, wherein the battery pack enclosure additionally includes a particle screen arranged in the endcap upstream of the ventilation plug and configured to filter debris out of the high-temperature gas.

8. The battery pack of claim 6, wherein the ventilation plug is constructed from one of metal and plastic and is configured to be breached by at least one of increased pressure and temperature when impinged on by the high-temperature gas.

9. The battery pack of claim 1, wherein the enclosure tray includes a false floor and the second compartment is incorporated into the false floor.

10. The battery pack of claim 9, wherein the vent channel is incorporated into the false floor.

11. A motor vehicle comprising:
a power-source configured to generate power-source torque; and
a battery pack configured to supply electrical energy to the power-source, the battery pack including:
a plurality of battery cells;
a battery pack enclosure surrounded by an external environment, the battery pack enclosure including:
an enclosure tray having a first compartment configured to house the plurality of battery cells and a second compartment configured to collect high-temperature gas emitted by at least one of the plurality of battery cells during a thermal runaway and expel the high-temperature gas to the external environment; and
an enclosure cover configured to engage the enclosure tray and seal the battery pack enclosure, wherein the first compartment is arranged between the second compartment and the enclosure cover;
a temperature-sensitive component arranged inside the battery pack enclosure between the second compartment and the enclosure cover; and
a vent channel fluidly connecting the first compartment to the second compartment and configured to direct the high-temperature gas from the first compartment to the second compartment, thereby diverting the high-temperature gas away from the temperature-sensitive component.

12. The motor vehicle of claim 11, wherein the battery pack enclosure additionally includes a baffle arranged in a flow of the high-temperature gas directed by the vent channel and configured to slow and cool the high-temperature gas prior to the high-temperature gas entering the second compartment.

13. The motor vehicle of claim 12, wherein the enclosure tray includes an endcap in fluid communication with the second compartment.

14. The motor vehicle of claim 13, wherein the baffle is located in the endcap.

15. The motor vehicle of claim 13, wherein the endcap is constructed as a separate component from the first and second compartments and joined to the second compartment to thereby form the enclosure tray.

16. The motor vehicle of claim 13, wherein the battery pack includes a ventilation plug arranged in the battery pack enclosure, and wherein the ventilation plug is configured to interface with the endcap and open fluid communication between the endcap and the external environment when the ventilation plug is impinged on by the high-temperature gas.

17. The motor vehicle of claim 16, wherein the battery pack enclosure additionally includes a particle screen arranged in the endcap upstream of the ventilation plug and configured to filter debris out of the high-temperature gas.

18. The motor vehicle of claim 16, wherein the ventilation plug is constructed from one of metal and plastic and is configured to be breached by at least one of increased pressure and temperature when impinged on by the high-temperature gas.

19. The motor vehicle of claim 11, wherein the enclosure tray includes a false floor and the second compartment is incorporated into the false floor, and wherein the vent channel is incorporated into the false floor.

20. A battery pack comprising:
a plurality of battery cells organized in battery cell modules;
a battery pack enclosure surrounded by an external environment, the battery pack enclosure including:
an enclosure tray having a first compartment configured to house the plurality of battery cells and a second compartment configured to collect high-temperature gas emitted by at least one of the plurality of battery cells during a thermal runaway and expel the high-temperature gas to the external environment; and
an enclosure cover configured to engage the enclosure tray and seal the battery pack enclosure, wherein the first compartment is arranged between the second compartment and the enclosure cover;
a temperature-sensitive component arranged inside the battery pack enclosure between the second compartment and the enclosure cover;
a vent channel fluidly connecting the first compartment to the second compartment and configured to direct the high-temperature gas from the first compartment to the second compartment, thereby diverting the high-temperature gas away from the temperature-sensitive component;
a baffle arranged in a flow of the high-temperature gas directed by the vent channel and configured to slow and cool the high-temperature gas prior to the high-temperature gas entering the second compartment; and
a ventilation plug arranged in the battery pack enclosure and configured to open fluid communication between the second compartment and the external environment when the ventilation plug is impinged on by the high-temperature gas.
